(19) United States
(12) Patent Application Publication
(10) Pub. No.: US 2008/0085260 A1
(43) Pub. Date: Apr. 10, 2008

(54) Formulation for repelling insects and attracting fish

(76) Inventor: Michael Tinghitella, Salem, OR (US)

Correspondence Address: CARL D. CROWELL, P.O. BOX 923, SALEM, OR, 97308-0923, US

(21) Appl. No.: 11/973,924

(22) Filed: Oct. 10, 2007

Related U.S. Application Data
(60) Provisional application No. 60/828,954, filed on Oct. 10, 2006.

(51) Int. Cl. A01N 65/00; A01P 17/00

(52) U.S. Cl. 424/84

(57) ABSTRACT

Disclosed is a novel formulation and process for the effective repelling of insects without the adverse effects of repelling fish. Further the formulation is stable enough for long term storage, has a high rate of durability on the skin, and has been shown in cases to attract fish.

### CROSS REFERENCE TO RELATED APPLICATIONS

This application contains disclosure from and claims the benefit under Title 35, United States Code, §119(e) of the following U.S. Provisional Application: U.S. Provisional Application Ser. No. 60/828,954 Filed Oct. 10, 2006 entitled FORMULATION FOR REPELLING INSECTS AND ATTRACTING FISH.

### FIELD OF THE INVENTION

The invention relates to an insect repellent and more particularly to an insect repellent that will not be offensive to fish while also working to attract fish.

### BACKGROUND OF THE INVENTION

In the course of fishing, fishermen are exposed to large bodies of water which are often locales for insect pests, such as mosquitoes, ticks, flies, midges, chiggers, and fleas. These insects are not only a nuisance, but they can also pose a health risk by transmitting hundreds of diseases to its victims. For example, mosquitoes are known to contribute to the spread of malaria, yellow fever, dengue fever, and the West Nile virus.

Over the years, there has been a high demand for effective insect repellents. The majority of prior insect repellents such as those described in U.S. Pat. No. 5,575,988, No. 3,590,118, No. 3,590,118, No. 4,477,467 and No. 4,304,591 contain N,N-diethyl-m-toluamide (DEET) as the main active ingredient. Although DEET and similar chemicals are effective in repelling biting insects, it is also very effective in repelling other animals including fish. Fish of all species, especially freshwater fish such as bass, trout, catfish, walleye, and pan fish have a very acute olfactory sense that alerts them to danger. Any unknown scent on a fishing lure or fishing line can deter fish from taking the bait.

It is known that various naturally occurring substances work as insect repellants in nature. It is also known that there are currently DEET free alternative insect repellents in the market. However, none of the prior art insect repellents were designed with the interest of a fisherman in mind. U.S. Pat. No. 6,548,085 for example teaches of an insecticide that contain essential oils such as garlic oil, peppermint oil, and lemongrass oil, but once again like the rest of the prior art, it was not designed and tested to help mask offensive odors noticeable by fish nor were they designed to contain ingredients that actually induce more fish to bite.

Fisherman have been unable to find an insect repellant that is effective without also suffering the effects of repelling the sought after fish. When insect repellants are used, there is the burden of ensuring that the chemicals do not come in contact with the fishing gear, line, rod, hands, lure or bait. This creates a notable obstacle in the use of such insect repellants. Many professional tournament fishermen will not apply insect repellent even in mosquito infested areas because of the fear of repelling fish that would cost them thousands of dollars in winnings.

The present invention solves the above illustrated problem by teaching of an all natural insect repellents that not only contain ingredients effective in repelling insects, but also ingredients that help attract fish while fishing.

### SUMMARY OF THE INVENTION

Disclosed is a novel formulation and process for the effective repelling of insects without the adverse effects of repelling fish. Furthermore the formulation is stable enough for long term storage, has a high rate of durability on the skin, and has been shown in cases to attract fish. The formulation includes both active and inert ingredients. The active ingredients contain garlic concentrate or other garlic extracts, Potassium Sorbate, and one or more essential oil including: cinnamon oil, lemongrass oil, and terpeneless peppermint oil. The inert ingredients include water, hydrogenated castor oil, sorbitol, and citric acid. The novelty of this invention is that none of the proposed ingredient is individually offensive to fish and tests have shown that the above combinations even attract and promote fish to bite.

The resulting insect repellent is in an aqueous stage and is effective in repelling biting insects and also effective in attracting fish. The resulting insect repellent can be applied to clothes, human skin, fishing equipment or anything susceptible to insect bites. The resulting insect repellent can also be used as fish attractant to apply onto fishing lures, baits, and line to help stimulate bites from fish of all species.

### DETAILED DISCUSSION OF THE PREFERRED EMBODIMENTS

Three embodiments of the formula are disclosed, measures by volume:

The first embodiment contains active ingredients Potassium Sorbate (0.5%), Garlic Concentrate (09.0%), Cinnamon Oil (0.18%) and inert ingredients Water, Hydrogenated Castor oil, Sorbitol, and Citric Acid.

The second embodiment contains active ingredients Potassium Sorbate (0.5%), Garlic Concentrate (09.0%), Lemongrass Oil (02.0%), Peppermint oil (terpeneless) (01.0%) and inert ingredients Water, Hydrogenated Castor oil, Sorbitol, and Citric Acid.

The third embodiment contains active ingredients Potassium Sorbate (0.5%), Garlic Concentrate (09.0%), Peppermint oil (terpeneless) (01.0%) and inert ingredients Water, Hydrogenated Castor oil, Sorbitol, and Citric Acid.

The garlic concentrate used is generally natural garlic and water combined. It is disclosed that in the preferred embodiment, aged garlic is used for increased effectiveness with reduced offensive odors.

Those inert ingredient measures that are not disclosed as specific are principally water, with the balance of the ingredients in lesser amounts without necessary ratios.

The disclosed volumes are for a guideline of the preferred embodiments. The invention is not limited to the specific measures.

In formulation the components may be mixed in a conventional method.

### EXAMPLE 1

Two lures were attached to the same fishing line one foot apart and the preferred embodiments were applied to lure 1, and nothing was applied to lure 2. After extensive testing, it was shown that lure 1 covered with the preferred embodiments caught 40% more fish than lure 2.

### EXAMPLE 2

Field tests shows that all three embodiments were effective in repelling biting insects such as mosquitoes, ticks, flies, midges, chiggers, and fleas when applied to the body and clothe of fishermen.

Method of Use

In preferred use the formulation may be applied to skin, clothing, or articles such as a boat or platform through spray, painting or manual spreading for effective repelling of insects. The formulation may also be sprayed onto fishing lures and bait and also can be, if desired, injected into plastic or rubber lures for further sustained longevity of fish attraction underwater.

Further benefits may be obtained through the application of the formulation to fishing gear such as fishing bait, lures and line as the formulation is pleasing and a fish attractant.

Accordingly, the reader will see that the insect repellent of the various embodiments is effective in repellency of insects while at the same time contributes to the attraction of fish. In addition, the benefit of the described embodiments include its stability in mixing, cooling and conditioning of the skin of people, appealing scent for humans, naturalness ingredients, and the meeting of EPA exemption requirements

Throughout the specification the aim has been to describe the invention without limiting the invention to any one embodiment or specific collection of features. Persons skilled in the relevant art may realize variations from the specific embodiment that will nonetheless fall within the scope of the invention. For example, the described insect repellent embodiments are not limited to fishermen, but can be used as insect repellent for gardeners, campers, and pets or in any other situations where insect repellent is needed. This embodiment need not be used to repel insect, but may be used only to attract fish. The percentages by volume of active ingredients are not limited to exact percentage given in the preferred embodiments. The percentages by volume of inert ingredients are not limited to an exact percentage.

Accordingly, the scope of the invention should be determined not by the embodiments illustrated, but by the appended claims and their legal equivalents.

We claim:

1. A composition for an insect repellent and fish attractant comprising:
a. a combination of active ingredients and inert ingredients; wherein said active ingredients contain a percentage of garlic, a percentage of potassium sorbate, and an at least one essential oil; and wherein said inert ingredients contain a percentage of water, a percentage of hydrogenated caster oil, a percentage of sorbitol, and a percentage of citric acid.

2. The composition for an insect repellent and fish attractant of claim 1, wherein the said at least one essential oil includes one or more of the following: a peppermint oil, a lemongrass oil, and a cinnamon oil.

3. The composition for an insect repellent and fish attractant of claim 2, wherein said peppermint oil is terpeneless.

4. The composition for an insect repellent and fish attractant of claim 1, wherein the said percentage of garlic may include at least one of the following: a garlic concentrate, a garlic oil, and a garlic extract.

5. A method of preparing and applying a composition for repelling insects while attracting fish comprising the steps of:
a. adding a combination of active ingredients and inert ingredients; wherein said active ingredients contain a percentage of garlic, a percentage of potassium sorbate, and an at least one essential oil; and wherein said inert ingredients contain a percentage of water, a percentage of hydrogenated caster oil, a percentage of sorbitol, and a percentage of citric acid; and
b. applying said combination of active ingredients and inert ingredients to a target subject.

6. The method of preparing and applying a composition for repelling insects while attracting fish of claim 5, wherein the said at least one essential oil includes one or more of the following: a peppermint oil, a lemongrass oil, and a cinnamon oil.

7. The method of preparing and applying a composition for repelling insects while attracting fish of claim 6, wherein said peppermint oil is terpeneless.

8. The method of preparing and applying a composition for repelling insects while attracting fish of claim 5, wherein the said percentage of garlic may include at least one of the following: a garlic concentrate, a garlic oil, and a garlic extract.

9. The method of preparing and applying a composition for repelling insects while attracting fish of claim 5, wherein said target subject includes but is not limited to clothes, human skin, fishing equipment, pets and livestock.
